(19) United States
(12) Patent Application Publication
(10) Pub. No.: US 2026/0145740 A1
(43) Pub. Date: May 28, 2026

(54) MOTOR-VEHICLE FRAME ASSEMBLY PROVIDED FOR ABSORBING IMPACT ENERGY IN CASE OF A FRONTAL IMPACT

(71) Applicant: Stellantis Europe S.p.A., Torino (IT)

(72) Inventors: Corrado BORRELLI, Torino (IT); Sergio BIANCO, Torino (IT); Daniele GUIDI, Modena (IT); Cecilia GAZZOTTI, Modena (IT); Linda BIANCO, Torino (IT)

(73) Assignee: Stellantis Europe S.p.A., Torino (IT)

(21) Appl. No.: 19/121,519

(22) PCT Filed: Sep. 27, 2023
(86) PCT No.: PCT/IB2023/059597

§ 371 Date: Apr. 16, 2025

(30) Foreign Application Priority Data
Oct. 25, 2022 (IT) 102022000021972

(51) Int. Cl. B62D 21/15

(52) U.S. Cl. CPC B62D 21/152

(57) ABSTRACT

A motor-vehicle frame assembly for absorbing impact includes a cross member with a central portion and two end portions, a pair of longitudinal structural elements connected respectively to one end portion of the cross member, and a pair of longitudinal struts connected respectively and rearwardly to a longitudinal structural element. Each longitudinal strut is connected to the longitudinal structural element by a reinforcement and connection plate between the structural element and the longitudinal strut. An auxiliary structural unit is connected to the plate at an upper portion of the plate vertically projecting beyond the strut. The auxiliary structural units are extended above the struts and along a direction parallel to the longitudinal struts to absorb impact energy in case of impact involving the vehicle at a height higher than the struts, without directly involving the cross member and the struts.

### FIELD OF THE INVENTION

The present invention relates in general to a motor-vehicle frame and in particular to a motor-vehicle frame assembly provided for absorbing impact energy in case of a frontal impact of the vehicle, comprising:
a cross member including a central portion and two end portions, configured to absorb at least part of the impact energy in case of a frontal impact of the vehicle,
a pair of longitudinal structural elements connected respectively to one end portion of the cross member,
a pair of longitudinal struts connected respectively and rearwardly to a longitudinal structural element, each strut being extended along a direction parallel to the longitudinal direction of the vehicle.

### PRIOR ART

Frame assemblies of the type indicated above have been used for some time in vehicles, for absorbing at least part of the energy of a frontal impact, in order to comply with several homologation requirements related to checking safety in case of a destructive impact. These assemblies must be designed in such a way as to obtain the desired energy absorption capacity, without however increasing the weight of the frame excessively and without taking complex configurations which are laborious and expensive to construct. Document US11180194 illustrates a solution of the type indicated above.

The present invention starts from the desire to make a motor-vehicle frame assembly which allows to reduce as much as possible the damage deriving from frontal impacts, above all in the case in which the external object which impacts the front part of the vehicle is extended to a height from the ground greater than that of the cross member and longitudinal struts.

This need is particularly felt in the case of electric or hybrid propulsion vehicles, since high voltage components and instruments are included in the engine compartment of the vehicle, damage to which can cause dangerous consequences for the occupants on board.

### OBJECT OF THE INVENTION

It is therefore an object of the present invention to provide a motor-vehicle frame assembly which meets the above mentioned requirements.

More particularly, an object of the present invention is to provide a motor-vehicle frame assembly, of the type indicated at the beginning of the present disclosure, which has a high impact energy absorption capacity, to avoid catastrophic damage to the components present in the engine compartment of the motor-vehicle.

A further object of the invention is to achieve the aforementioned objective with a frame assembly having an extremely simple configuration, involving correspondingly simple and economical manufacturing operations.

A further object of the invention is to achieve the above objectives without requiring any appreciable increase in the weight of the frame of the motor-vehicle with respect to known solutions.

Still a further object of the invention is to provide a frame assembly of the type indicated above which can be easily implemented on various motor-vehicle models with different dimensions and structures.

### SUMMARY OF THE INVENTION

The objects listed above are achieved by a motor-vehicle frame assembly according to the contents of the appended claims.

Further features of the invention are indicated in the attached dependent claims.

### BRIEF DESCRIPTION OF THE FIGURES

Further features and advantages of the invention will emerge from the following description with reference to the attached drawings, provided purely by way of non-limiting example, in which:

FIGS. 1A, 1B illustrate respectively a side view and an elevation view of a motor-vehicle subjected to a frontal impact,

FIG. 2 is a perspective view of a motor-vehicle frame assembly according to a preferred embodiment of the present invention,

FIGS. 3, 4 are respectively a side view and an elevation view of some components illustrated in FIG. 2,

FIG. 5 is a cross-sectional view of the components illustrated in FIGS. 3, 4, according to the plane A-A indicated in FIG. 3,

FIGS. 6, 7 are respectively a perspective view and an exploded perspective view of a structural unit configured to absorb impact energy, included in the frame assembly according to the present invention,

FIGS. 8A-8C are side views of a frame assembly according to the invention, illustrating a time sequence of an external object impacting the frame assembly frontally,

FIG. 8D is a view similar to the previous figure illustrating various components and instruments located in the engine compartment of the motor-vehicle, and

FIG. 9 shows two graphs which represent some advantageous effects of the invention, with respect to the prior art.

### DETAILED DESCRIPTION OF DIFFERENT EMBODIMENTS

Various specific details are illustrated in the following description aimed at an in-depth understanding of examples of one or more embodiments. The embodiments may be made without one or more of the specific details, or with other methods, components, materials, etc. In other cases, known structures, materials or operations are not shown or described in detail to avoid obscuring various aspects of the embodiments. Reference to “an/one embodiment” within the framework of this description is to indicate that a particular configuration, structure, or feature described in relation to the embodiment is comprised in at least one embodiment. Thus, phrases such as “in an/one embodiment”, which may appear at various points in this specification, do not necessarily refer to the same embodiment. Furthermore, particular conformations, structures or features may be suitably combined in one or more embodiments and/or associated with the embodiments in a manner other than as illustrated herein, so that for example a feature exemplified herein in relation to a figure it can be applied to one or more embodiments exemplified in a different figure.

The references shown here are for convenience only and therefore do not limit the extent of protection or the scope of the embodiments.

In the attached drawings, the reference number 1 indicates as a whole a motor-vehicle frame assembly, which can be used as a front module or a rear module, with impact energy absorption capacity in case of a frontal impact. The phrase frontal impact means an impact between an external object and a vehicle V, along a trajectory substantially corresponding to the longitudinal axis of the vehicle V, whether in the event that the moving vehicle V impacts a stationary or moving obstacle, or in the event that a moving obstacle impacts the stationary or moving vehicle.

In the example described below, reference will be made to a frame assembly usable as a front module, it being understood that what is indicated herein is naturally also applicable to the case of a rear module.

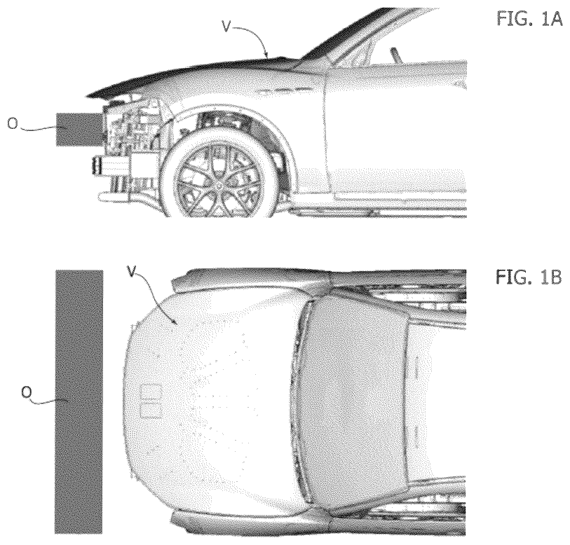

FIGS. 1A, 1B are respectively a side view and an elevation view of a motor-vehicle V involved in a frontal impact with an external object O. As will be apparent from the following description, the frame assembly 1 according to the present invention is arranged and configured to absorb impact energy in case of frontal impacts involving the vehicle at a given height.

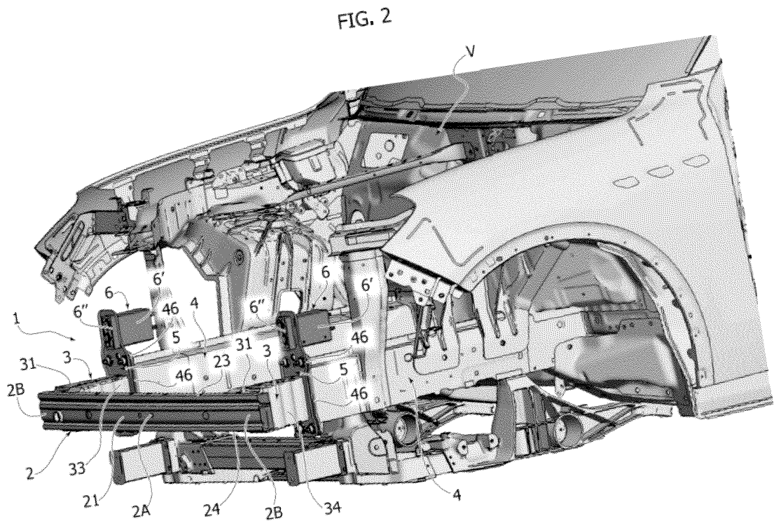

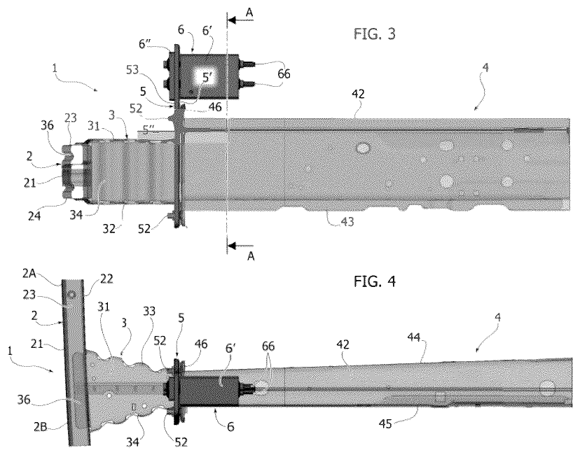

FIG. 2 is a perspective view of a frame assembly 1 according to a preferred embodiment of the present invention, assembled to the frame of the motor-vehicle. FIGS. 3, 4 are respectively a side view and an elevation view of the frame assembly 1.

With reference to the embodiment illustrated in the attached drawings, the frame assembly 1 comprises a cross member 2 with a central portion 2A and end portions 2B, configured to absorb at least part of the impact energy in case of a frontal impact.

The cross member 2 has a structure made of metallic material, for example aluminum or steel, including-with reference to the final configuration assembled on the vehicle-a front wall 21, a rear wall 22, an upper wall 23 and a lower wall 24.

In the specific example illustrated in FIG. 2, which however is not to be understood in a limiting sense, the cross member 2 is made of steel. The cross member 2 could be obtained from one or more folded and welded sheet metal elements.

In one or more embodiments of the invention, the end portions 2B of the cross member 2 have an inclined arrow-shaped configuration, with respect to the central portion 2A. This configuration is obtained by means of a permanent deformation operation of the initially straight cross member 2.

Still with reference to FIG. 2, the frame assembly 1 comprises a pair of longitudinal structural elements 3 connected respectively to one end portion 2B of the cross member 2 at the rear wall 22. The structural elements 3 (commonly called “crashbox”) are provided for absorbing—at least part of—the impact energy in case of low or high speed impacts.

In a per se known way, the longitudinal structural elements 3 extend perpendicularly to the central portion 2A of the cross member 2 and along a direction parallel to the longitudinal direction of the vehicle. With reference to the assembled condition illustrated in FIG. 2, each longitudinal structural element 3 comprises a structure including a horizontal upper wall 31, a horizontal lower wall 32, an internal side wall 33 facing the center of the cross member 2, an external side wall 34, a rear wall and a front wall 36 connected to the end portion 2B of the cross member 2.

Each longitudinal structural element 3 also has a structure made of sheet metal, for example steel or aluminium. The materials of the cross member 2 and longitudinal structural elements 3 must be materials compatible with each other to allow the welding operations necessary to rigidly connect these elements together. As an alternative to welding and/or in addition to it, gluing of these elements together can be provided. In the latter case, the materials of the cross member 2 and of the reinforcing structural elements 3 can also be materials which cannot be welded together.

In the case of the specific example illustrated, the structure of each longitudinal structural element 3 comprises side walls 33, 34 having a substantially undulating shape with crests and recesses alternating with each other. This feature favors the collapse of the structure 3 at relatively low impact speeds, obtaining a significant energy absorption. Still with reference to the specific example illustrated, it should be noted that the front wall 36 is larger in size than the extension of the rear wall (opposite the front wall 36), and consequently the side walls 33, 34 have a general oblique shape, giving the structure of the element 3 a substantially tapered conformation from the front wall 36 towards the rear wall.

The frame assembly 1 also comprises a pair of longitudinal struts 4 frontwardly connected to a respective longitudinal structural element 3 at the rear of the respective longitudinal structural element 3. The longitudinal struts 4 extend in a direction parallel to the longitudinal direction of the vehicle V, starting from the rear part of the longitudinal structural element 3. The longitudinal strut 4 comprises a front wall, a rear wall, an upper wall 42, a lower wall 43 and side walls 44, 45, with reference to the assembled configuration shown in the FIG. 2.

In a per se known manner, the frame assembly 1 comprising the cross member 2, the structural elements 3 and the longitudinal struts 4 are arranged to absorb at least part of the impact energy in case of a frontal impact, in order to comply with the safety homologation requirements.

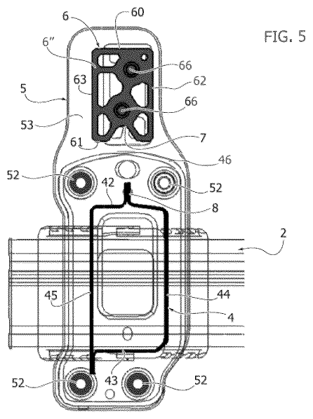

According to a feature of the present invention, each longitudinal strut 4 is connected to the respective longitudinal structural element 3 by means of a reinforcement and connection plate 5 interposed between the rear wall 35 of the longitudinal structural element 3 and the front wall 40 of the longitudinal strut 4 In one or more embodiments, the reinforcement and connection plate 5 is a plate welded to the rear end of the longitudinal structural element 3, intended to be used to connect the longitudinal elements 3 to the longitudinal struts 4. As shown in the FIGS. 2-7, each plate 5 is provided with holes 51 for the engagement of connecting bolts 52 to connect the plate 5 to corresponding flanges 46 associated with said longitudinal struts 4.

According to an essential feature of the present invention, the frame assembly 1 comprises a pair of auxiliary structural units 6 configured to absorb impact energy in case of a frontal impact. Each auxiliary structural unit 6 is rigidly connected to a respective reinforcement and connection plate 5, at an upper portion 53 of the plate 5 which vertically projects-in the assembled configuration-beyond the upper wall 42 of the longitudinal strut 4. Therefore, as illustrated in FIGS. 2, 3, the auxiliary structural units 6 are spaced at a height from the ground which is higher than that of the struts 4, so as to create additional energy absorbing elements with respect to the struts 4 and the cross member 2.

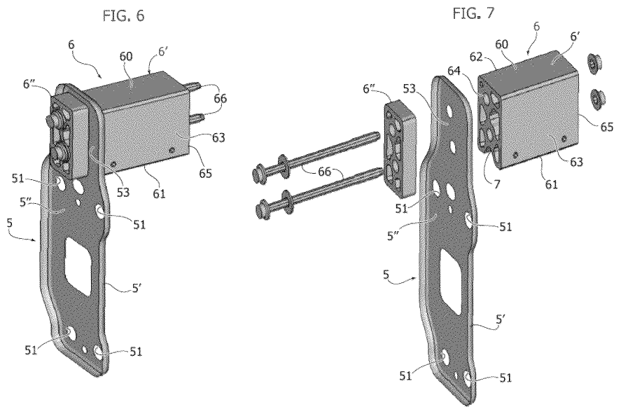

In one or more embodiments, as in the one illustrated in FIGS. 6, 7, each auxiliary structural unit 6 comprises at least one rigid body 6′, 6″ connected to the upper portion 53 of the connection plate 5. According to the illustrated embodiment, said at least one rigid body 6′, 6″ is an extruded body, obtained by means of an extrusion process, made of steel or aluminium, for example. The rigid body—for example with a quadrangular section—comprises an upper wall 60, a lower wall 61, two side walls 62, 63, a front wall 64 and a rear wall 65 (with reference to the final assembled configuration of FIG. 2). The extension of the walls 60, 61, 62, 63, 64, 65 can be sized in order to meet certain energy absorption capacities according to the installation spaces available on the vehicle.

According to the embodiment illustrated in the annexed drawings, the auxiliary structural unit 6 is rigidly connected to the upper portion 53 of the plate 5 by means of a pair of bolts 66 comprising through screws which cross the auxiliary structural unit 6 along a longitudinal direction. Alternatively, the unit 6 can be rigidly connected to the plate 6 by means of a weld line or other joining means.

According to the preferred embodiment, the auxiliary structural unit 6 comprises a first rigid body 6′ and a second rigid body 6″ connected by the same bolts 66 so that the first body 6′ and the second body 6″ are respectively in contact with a rear face 5′ and a front face 5″ of the connection and reinforcement plate 5. To effectively achieve the energy absorption effect in case of a frontal impact, the first (rear) body 6′ has significantly larger dimensions than those of the second (front) body 6″. With reference to the first (rear) body 6′, it should be noted that the extension of the side walls 62, 63 is greater than that of the front and rear walls 64, 65. Observing the side view of FIG. 3, it should be noted that the first (rear) body 6′ extends parallel to the longitudinal strut 4 starting from the rear face 5′ of the connection plate 5, while the second (front) body 6″ extends from the front face 5″ of the connection plate 5.

FIG. 6 is a cross-sectional view according to the plane A-A of FIG. 3. As illustrated in this figure, the auxiliary structural unit 6 preferably has a central recess 7 along its lower wall 61 suitable for receiving, during any deformation caused by impact, a central upper flange 8 obtained on the upper wall 42 of the longitudinal strut 4. Still with reference to this figure, it should also be noted that the auxiliary structural unit 6 can include a plurality of lightening sections to reduce the overall weight of the unit 6.

Thanks to the features described above, these auxiliary structural units 6 are configured and positioned to absorb the energy deriving from frontal impacts involving the vehicle V at a higher height from the ground than that of the cross member 2 and struts 4, in the case in which the external object O, which impacts the vehicle V frontally, does not involve the cross member 2 and the struts 4 frontally. In this context, consider for example a frontal impact of a frame according to the prior art, with a rear part of a truck which it does not engage the struts 4, therefore hitting a weak part of the frame without impact energy absorbing structural elements. Thanks to the features of the invention, in case of an impact of this type, the components of the vehicle V present in the engine compartment are protected even if the cross member 2 and the struts 4 do not frontally intercept the external object O which impacts the vehicle V.

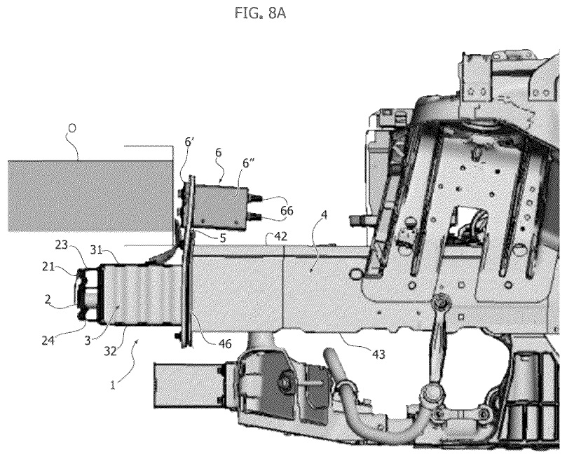

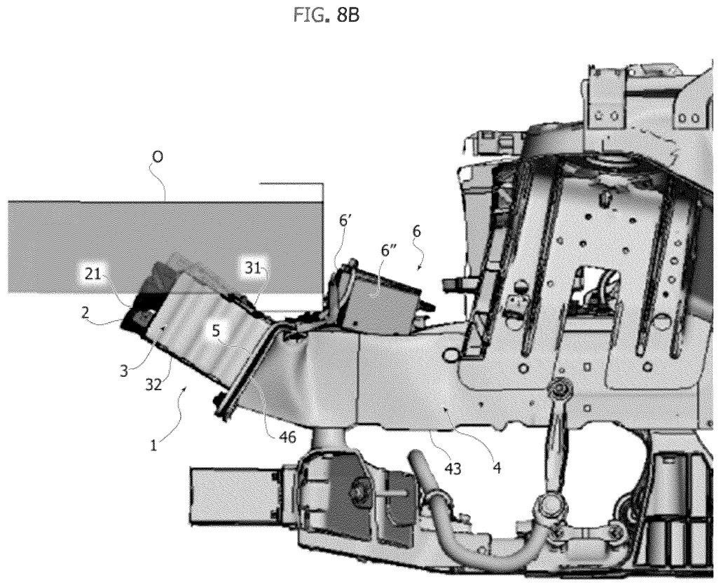

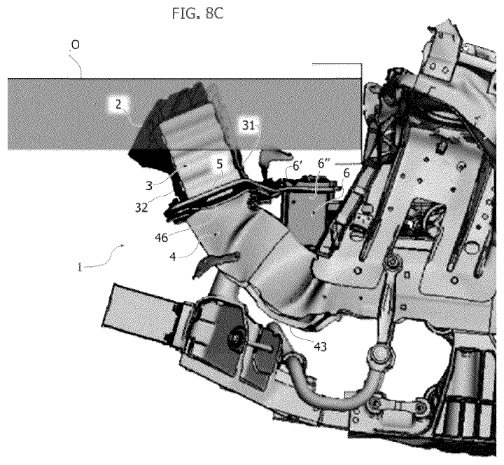

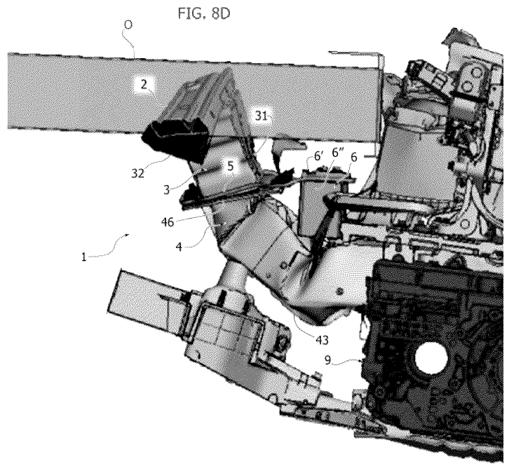

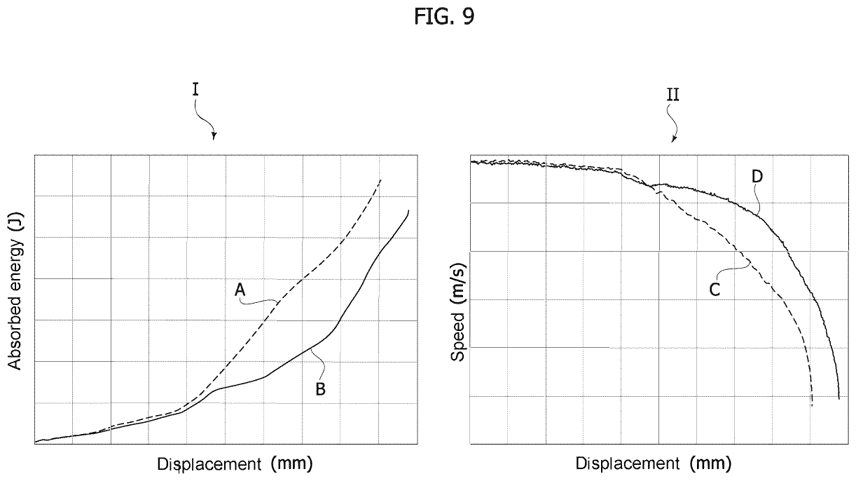

FIGS. 8A-8C illustrate a time sequence in which the frame assembly 1 according to the present invention is subjected to a frontal impact with an external object O which impacts the vehicle at a higher height from the ground than that of the struts 4 and cross member 2.

As illustrated in FIG. 8A, unlike a frame according to the prior art in which the features described above relating to the auxiliary structural units 6 are not provided, the external object O, before impacting the engine compartment of the vehicle V and the respective components, impacts against auxiliary structural units 6.

FIG. 8B illustrates a subsequent time phase with respect to that of FIG. 8A, in which the auxiliary structural element 6 is deformed, bending towards the struts 4 and carrying the structural elements 3 upwards by inertia.

FIG. 8C illustrates the external object O which impacted the engine compartment of the vehicle V, at a speed lower than that expected without the intervention of the auxiliary units 6.

As previously indicated, the frame assembly 1 according to the present invention is particularly useful in the case of electric or hybrid propulsion vehicles, since the engine compartment is equipped with various components/instruments which must necessarily be protected, both to avoid costly repairs, and to ensure the safety of the occupants. In this context, FIG. 8D illustrates a similar view with respect to FIG. 8C, in which the engine compartment includes and is equipped with components, such as an electric propulsion unit 9.

FIG. 9 illustrates a pair of graphs I, Il showing some advantageous features deriving from the invention. Graph I illustrates the energy absorbed by the vehicle V, showing the displacement (millimeters) on the horizontal axis and the absorbed energy (J) on the vertical axis. Graph I shows a first curve A relating to a vehicle frame equipped with auxiliary structural units 6 and a curve B relating to a vehicle frame according to the prior art. It should be noted that the energy absorbed by the vehicle is considerably higher than in the prior art.

FIG. 9 further illustrates a second graph II showing vehicle speed, wherein the horizontal axis indicates displacement (millimeters) and the vertical axis illustrates speed (m/s). Graph II shows a first curve C relating to a vehicle frame equipped with auxiliary structural units 6 and a curve D relating to a vehicle frame according to the prior art.

Of course, without prejudice to the principle of the invention, the details of construction and the embodiments may vary widely with respect to what has been described and illustrated purely by way of example without thereby departing from the scope of the present invention.

1. Motor-vehicle frame assembly provided for absorbing impact energy in case of a frontal impact of the vehicle, comprising:
a cross member including a central portion and two end portions, configured to absorb at least part of the impact energy in case of a frontal impact of the vehicle,
a pair of longitudinal structural elements connected respectively to one end portion of the cross member, extending along a direction parallel to the longitudinal direction of the vehicle, wherein each longitudinal structural element of the pair of longitudinal structural elements comprises a horizontal upper wall, a horizontal lower wall, an inner side wall facing the center of the cross member outer side wall, a rear wall and a front wall connected to the cross member,
a pair of longitudinal struts connected respectively and rearwardly to a longitudinal structural element of the pair of longitudinal structural elements, each strut of the pair of longitudinal struts including a horizontal upper wall, a horizontal lower wall, and being extended along a direction parallel to the longitudinal direction of the vehicle,
each longitudinal strut of the pair of longitudinal struts being connected to said longitudinal structural element of the pair of longitudinal structural elements by means of a reinforcement and connection plate interposed between the structural element and each longitudinal strut,
the plate being rigidly connected to an auxiliary structural unit configured to absorb impact energy, wherein the auxiliary structural unit is connected to the plate at an upper portion of the plate vertically projecting beyond the upper wall of each strut of the pair of longitudinal struts,
wherein the auxiliary structural unit extends above the struts and along a direction parallel to the longitudinal struts, so as to absorb impact energy in case of impact involving the vehicle at a height higher than that of the struts, without directly involving the cross member and the struts.

2. Frame assembly according to claim 1, wherein the auxiliary structural unit comprises at least one rigid body connected to the upper portion of the connection plate.

3. Frame assembly according to claim 2, wherein said at least one rigid body is an extruded body obtained by an extrusion process, made of steel or aluminum.

4. Frame assembly according to claim 1, wherein the auxiliary structural unit is rigidly connected to the upper portion of the plate by means of at least one through screw which crosses the auxiliary structural unit along a longitudinal direction.

5. Frame assembly according to claim 2, wherein the auxiliary structural unit comprises a first rigid body and a second rigid body respectively in contact with a rear face and a front face of the connection and reinforcement plate.

6. Frame assembly according to claim 5, wherein the first rigid body has a larger dimension than that of the second rigid body, wherein the first body extends parallel to the longitudinal strut with lateral walls having a larger dimension than that of the front wall in contact with the rear face of the plate.

7. Frame assembly according to claim 1, wherein the auxiliary structural unit comprises along its lower wall a central recess suitable for receiving, during any deformation caused by impact, a central upper flange obtained along the upper wall of a longitudinal strut of the pair of longitudinal struts.

8. Frame assembly according to claim 1, wherein the auxiliary structural unit comprises a plurality of lightening sections to reduce the overall weight of the unit.

9. Frame assembly according to claim 1, wherein the materials of the cross member and the longitudinal structural elements are compatible materials to enable welding operations for connecting to each other the cross member and the longitudinal structural elements.

10. Motor-vehicle comprising a frame assembly according to claim 1.
